(19) United States
(12) Patent Application Publication
(10) Pub. No.: US 2009/0276231 A1
(43) Pub. Date: Nov. 5, 2009

(54) Method and System for Job and Career Guidance, Planning, Strategy and Workforce Development

(75) Inventors: Michael N. Bazigos, Hastings-on-Hudson, NY (US); Peter J. Mitchell, Woodstock, GA (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 12/112,963

(22) Filed: Apr. 30, 2008

(51) Int. Cl. G06Q 99/00

(52) U.S. Cl. 705/1

(57) ABSTRACT

A method, system and computer program product for career guidance and planning, the method includes receiving an electronic request for guidance relating to procuring a job role in a particular job category; retrieving data relating to documented qualifications and retrieving data relating to the required qualifications necessary for at least one job role in the particular job category. The method and system also include comparing the documented qualifications with the required qualifications necessary for the at least one target job role in the particular job category and determining the differences between the documented qualifications and the required qualifications necessary for the at least one job role as well as displaying each difference between the documented qualifications and the required qualifications necessary for the at least one job role. The method and system also include retrieving data relating to the training necessary to address the skill gap between the documented qualifications and the required qualifications necessary for the at least one job role and providing at least one strategy and recommendation in response to the electronic request on how to efficiently develop the skills necessary to address the skill gap between the documented qualifications and the at least one target job role.

### I. FIELD OF THE INVENTION

This invention relates in general to the field of computer systems and human resource and workforce management, and in particular to an interactive computer based system for strategic career guidance, planning, transition and workforce management.

### II. DESCRIPTION OF THE PRIOR ART

In today's competitive, yet uncertain business environment, maintaining, developing and effectively managing human resources is often the difference between success and failure. Also, with the globalization of economies, strategic workforce development is no longer an option, but a necessity if the organization wishes to remain competitive on the world stage and be proactive in addressing trends for the industry to which the organization functions.

Employers are often seeking ways to evaluate the skill sets of a particular employee or a group of employees, to get the best and greatest value of the skill sets of the existing workforce, and to evaluate an individual or a group of employees in the workforce, to anticipate training needs, or future workforce development.

One such method is embodied in the published patent application entitled “Automated Life and Career Management Services,” U.S. Patent Publication 20050096973. This published application describes systems and methods for providing career management services to individuals over a network, such as the Internet. The integrated life and career management systems and methods allow individuals to dynamically and continuously record, witness, monitor, and manage their life and career development. Human resources professionals may access and reference information about individuals to render assistance to the individual. In one implementation, a dynamic personal growth and development profile is automatically constructed and recorded based on tests, instruments, and exercises taken by the individual. The profile provides a psychometric self-portrait of the individual among other information. A flexible life and career plan corresponding to the profile is generated, so as to provide guidance to the individual when life and career decisions are made.

Another approach is disclosed in the published application entitled “Career Planning Tool,” U.S. Patent Publication 20050114203. The published application discloses a career planning tool that features storing a set of roles for an organization, storing user information for a user, the user information including a plurality of earlier and later roles and automatically generating a career path based on the set of roles.

Another approach is disclosed in the published application entitled “Intelligent Job Matching System and Method,” U.S. Patent Publication 20060265270. This published application discloses a job searching and matching system and method that gathers job seeker information in the form of job seeker parameters from one or more job seekers, gathers job information in the form of job parameters from prospective employers and/or recruiters, correlates the information with past job seeker behavior, parameters and behavior from other job seekers, and job parameters. In response to a job seeker's query, it provides matching job results based on common parameters between the job seeker and jobs along with suggested alternative jobs based on the co-relationships and based on ratings and preferences provided by the job seeker in response to queries from the system in order to efficiently and accurately accommodate job seeker perception.

The system of the “Intelligent Job Matching System and Method” application correlates employer/recruiter behavior information with past employer/recruiter behavior, parameters and information concerning other job seekers, which are candidates to the employer, and resume parameters, and, in response to a Employer's query, provides matching job seeker results based on common parameters between the job seeker resumes and jobs along with suggested alternative job seeker candidates based on the identified co-relationships.

### III. SUMMARY OF THE INVENTION

Disclosed is a method for career guidance and planning, the method includes receiving an electronic request for guidance relating to procuring a job role in a particular job category; retrieving data relating to documented qualifications and retrieving data relating to the required qualifications necessary for at least one job role in the particular job category. The method also features comparing the documented qualifications with the required qualifications necessary for the at least one target job role in the particular job category and determining the differences between the documented qualifications and the required qualifications necessary for the at least one job role as well as displaying each difference between the documented qualifications and the required qualifications necessary for the at least one job role.

The method also features retrieving data relating to the training necessary to address the skill gap between the documented qualifications and the required qualifications necessary for the at least one job role and providing at least one strategy and recommendation in response to the electronic request on how to efficiently develop the skills necessary to address the skill gap between the documented qualifications and the at least one target job role.

Also disclosed is a method for workforce management and planning including receiving an electronic request for strategic guidance relating to procuring a job role in a particular job category, retrieving data relating to documented qualifications, and retrieving data relating to the qualifications necessary for at least one projected job role in said particular job category. The method includes comparing the documented qualifications with the projected qualifications necessary for the at least one future job role in said particular job category, determining the differences between said documented qualifications and said qualifications necessary for the at least one future job role, and determining the difference between said documented qualifications and the projected skill set requirements for said future job role.

The method also features displaying each difference between the documented qualifications and said projected skill set requirements for a job role in the future workforce, retrieving data regarding the training necessary to address the projected skill gap between the documented qualifications and the qualifications necessary for the at least one job role in said future workforce and providing at least one strategy and recommendation in response to said electronic request on how to develop the skills necessary to address the skill gap between said documented qualifications and the at least one job category in the employer's future workforce.

Also disclosed is a system for human resource management and career development featuring a computer network having a server coupled to at least one database, the database comprising a plurality of employee electronic resumes, each electronic resume defining the employee's experience via standardized skill sets associated with the employee's experience. The at least one database comprises a plurality of job roles each job role being defined at least by a group of standardized skill sets required by the job; the database being searchable at least by job role; job category; and one or more skill sets. The system server is further coupled to a computer network having training scheduling information and mentor information wherein an employee logs onto the computer network and initiates a job search based on one of the searchable fields, the server receives the search request and retrieves the employee's electronic resume, and retrieves data relating to the skill set necessary for at least one job role in view of the employee's job search request.

The system compares the user's documented skill set with the required skill set necessary for the at least one identified job role and determines the differences between the documented skill set and the required skill set necessary for the at least one identified job role. The system displays each difference between the documented skill set and the skill set necessary for the at least one identified job role through a graphical user interface and retrieves data relating to the training necessary to address the skill gap between the documented skill set and the skill set necessary for the at least one job role. The system also provides strategy and at least one recommendation through the graphical user interface in response to the electronic request on how to develop the documented skill set and address the skill gap between the documented skill set and the skill set required for the at least one identified job role.

Also disclosed is a computer program product comprising computer usable medium having a computer usable program code for career guidance and planning the computer program product featuring computer-usable program code for receiving an electronic request for guidance relating to procuring a job role in a particular job category and computer-usable program code for retrieving data relating to documented qualifications, as well as computer-usable program code for retrieving data relating to the required qualifications necessary for at least one job role in the particular job category. The computer program product also features computer-usable program code for comparing the documented qualifications with the qualifications necessary for the at least one target job role in the particular job category and computer-usable program code for determining the differences between the documented qualifications and the required qualifications necessary for the at least one job role.

The computer program product also features computer-usable program code for displaying each difference between the documented qualifications and the required qualifications necessary for the at least one job role and computer-usable program code for retrieving data relating to the training necessary to address the skill gap between the documented qualifications and the required qualifications necessary for the at least one job role. The computer also features computer-usable program code for providing strategy and at least one recommendation in response to the electronic request to address the skill gap between the documented qualifications and the at least one target job role.

### IV. BRIEF DESCRIPTION OF THE DRAWINGS

In order to describe the manner in which the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates an exemplarily flowchart of job search according to the disclosed method based on a particular target job role or category.

FIG. 2 illustrates an exemplarily flowchart of job search according to the disclosed method based on a skill set match search request.

FIG. 3 illustrates a block diagram of an exemplarily embodiment of the system for strategic career guidance, planning and strategic workforce management featuring the time cost and learning guidance tools.

FIG. 4 illustrates a screen shot of an example embodiment of the career guidance, planning and strategic workforce management tool showing a job category based search.

FIG. 5 illustrates a screen shot of an example embodiment of the career guidance, planning and strategic workforce management tool showing a skill set based search.

FIG. 6 illustrates a screen shot of an example embodiment of the career guidance, planning and strategic workforce management tool showing a graphical skill inventory assessment.

FIG. 7 illustrates a screen shot of an example embodiment of the career guidance, planning and strategic workforce management tool showing a graphical skill development map.

FIG. 8 illustrates a screen shot of an example embodiment of the career guidance, planning and strategic workforce management tool showing custom individualized skill development recommendations.

FIG. 9 illustrates a screen shot of an example embodiment of the career guidance, planning and strategic workforce management tool showing custom individualized skill development recommendations.

FIG. 10 illustrates an example embodiment of a system for system for strategic career guidance, planning and strategic workforce management.

### V. DETAILED DESCRIPTION

Various embodiments are discussed in detail below. While specific implementations of the disclosed technology are discussed, it should be understood that this is done for purposes of illustration. A person skilled in the relevant art will recognize that other components and configurations may be used without departing from the spirit and scope of the invention.

The disclosure relates to a system and method for strategic career management and planning and workforce management employing a job search tool that provides an evaluation of an employee's documented skill set in the context of a target job role or job category. The system and method provide skill set comparisons between the employee's documented skill set and the skill set necessary for the target job role or job category, and provides the employee with guidance and assistance in developing his or her skill set to satisfy the requirements of the target job role.

Another aspect of the system and method allow an employee to perform a skill set based search. The skill set match tool identifies job roles or job categories requiring skill sets that in some way overlap the employee's current skill set. This allows the employee to specify “close fit” job options that can be transitioned into quickly or with minimal training. The system and method further provide skill set comparisons between the employee's documented skill set and the skill set necessary for the returned “close fit” job roles or job categories, and in the event of a skill gap, provides the employee with guidance and assistance, in developing his or her skill set to satisfy the requirements of one or more identified jobs.

Another aspect of the system and method provide a powerful tool for workforce development. If an organization's management determines that it would like to grow the skill sets of a particular part of the workforce in a particular direction, (e.g. develop the foreign language skills of its technical staff). The guidance and assistance recommendations offered to the technical staff in response to a job role search may be tailored to also suggest foreign language training although foreign language training may not directly relate to the particular skill sets relevant to job role or job category returned by the search. This imbedded recommendation will, over time, have the effect of shaping the skill set of a significant portion of the technical workforce since the workforce will develop the imbedded skill adding it to the organization's technical staff skill set.

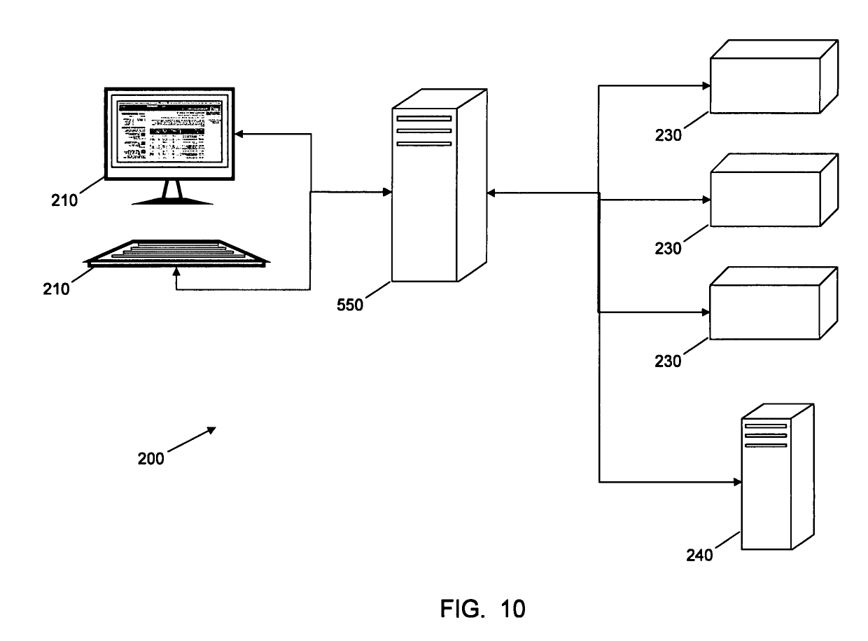

Referring now to the Figures, where like reference numbers denote like elements, FIG. 10 illustrates a example embodiment of a system for strategic planning career guidance panning and workforce management. The system 200 features a processor 550 coupled to a plurality of I/O devices 210 for interacting with the user. The processor 550 is also coupled to at least one memory device 230 and to other processors 240 via a network, or system bus.

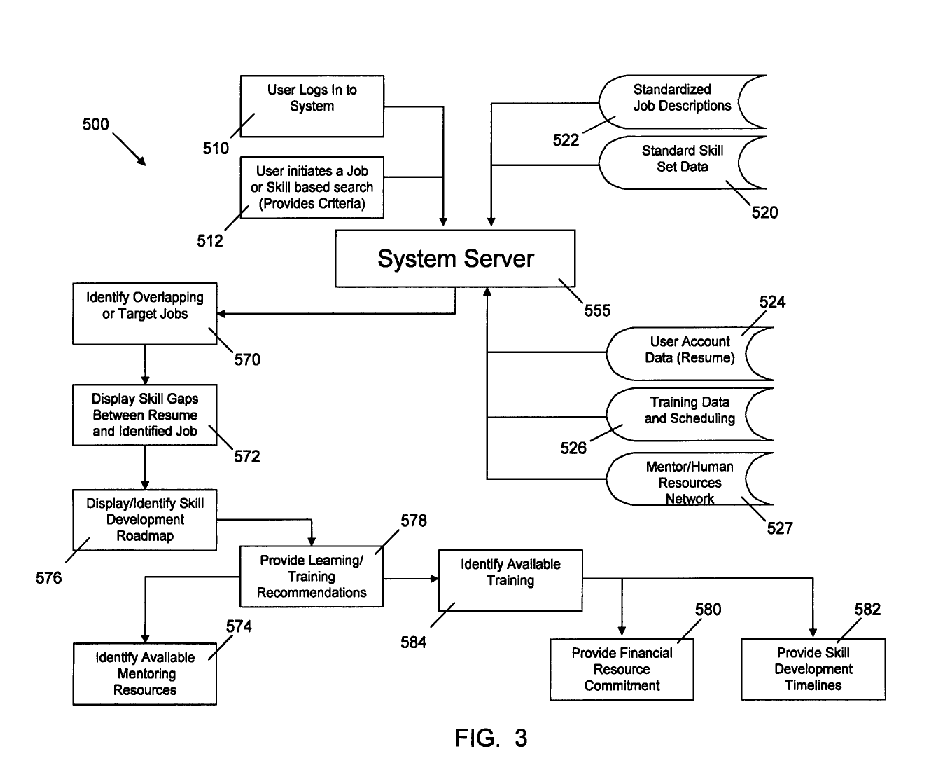

FIG. 3 illustrates a block diagram of an exemplarily system for strategic career guidance planning and strategic workforce management featuring a time cost estimator and learning guidance tool. The system features a system server 555 coupled to at least one database or computer readable medium giving the server access to the user's account data 524 or electronic resume.

When a user logs onto the system, information regarding their past jobs and current job is made available. This information may be entered or updated when the user logs on. Preferably the user is an employee, however a user's employment status is not limiting. The user may be an employee, a manager, or a human resource specialist providing advice to an employee or an outside party seeking employment.

The user account data 524 includes at least the employee's electronic resume comprising biographic information, current employment (job) information and current skill set information. The user account data 524 also may include the employee's education, evaluations, ratings, tenure, formal and informal training, scheduled training, past employment (jobs), attendance, past awards, disciplinary action, test scores, aptitudes, clearance levels or any other quantified data germane to employment decisions.

Preferably the employee logs onto the system and updates his resume periodically as his skill set evolves. An employee's electronic resume may also include his regional preferences or objections, age, unconventional experience, or skills unrelated to past or current employment.

The database or other computer readable medium also includes a plurality of job roles or job descriptions 522 and job categories. Each job category has at least one associated job role. Each job role 522, as well as the employee's current and past job descriptions, is associated with a group of pre-defined quantifiable individual skill sets 520 required by the particular job. Preferably, the skill sets are standardized and a quantifiable proficiency level is also associated with each skill that comprises the skill set. This expertise taxonomy may be manipulated or overridden by an individual business unit or department depending on the needs of the entity. For example the proficiency level for a particular skill may be reduced or increased or otherwise weighted depending on the needs of the entity.

The database or computer readable medium also includes training data and scheduling available to the employee. The training data and scheduling is associated with the development of particular skill sets that are defined and associated with the plurality of job descriptions.

The server is also coupled to at least one database or computer readable medium associated with contacts for mentoring assets or human resources assets who have information relating to the recommendations, training or job descriptions and job categories with which the employee wishes to investigate.

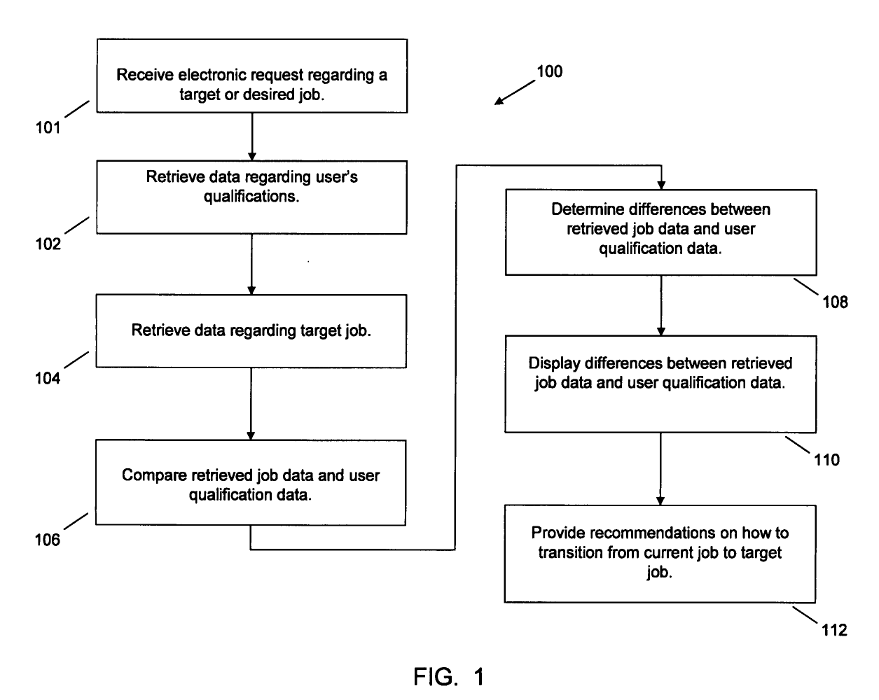

Referring now to FIG. 1 with continued reference to FIG. 3, FIG. 1 illustrates an exemplarily flowchart of job search according to the disclosed system and method based on a target job role or job category. Initially, a user will log onto the system 510. Once on the system, the user may update his or her electronic resume or initiate a job or skill set based search 512.

When the user initiates a job based search 100, the system 500 receives an electronic request for guidance regarding procuring a job or job role in a particular category selected by the user 101.

The system retrieves data regarding the user's qualifications 102. Specifically, the system retrieves the user's electronic resume 524 containing the user's skill set data. This user skill set data or user qualification data provides a starting point for the strategic planning or recommendations that will follow.

The system server then retrieves data relating to the qualifications necessary for at least one job description or job role in the particular job category specified by the user 104. This job qualification data includes data regarding the predefined skill sets 520 required for each of the specified jobs or job categories associated therewith. Preferably, the skill set data is standardized, and includes, tenure, and proficiency information associated with each skill, however, additional information may be considered.

The system compares the retrieved job data and the user qualifications data 106, and determines the difference between the retrieved job data and the user qualification data 108. Specifically, the system determines the skill set gaps, the individual skills missing from the user's current skill set in view of the skill sets required by the at least one specified job role or job category.

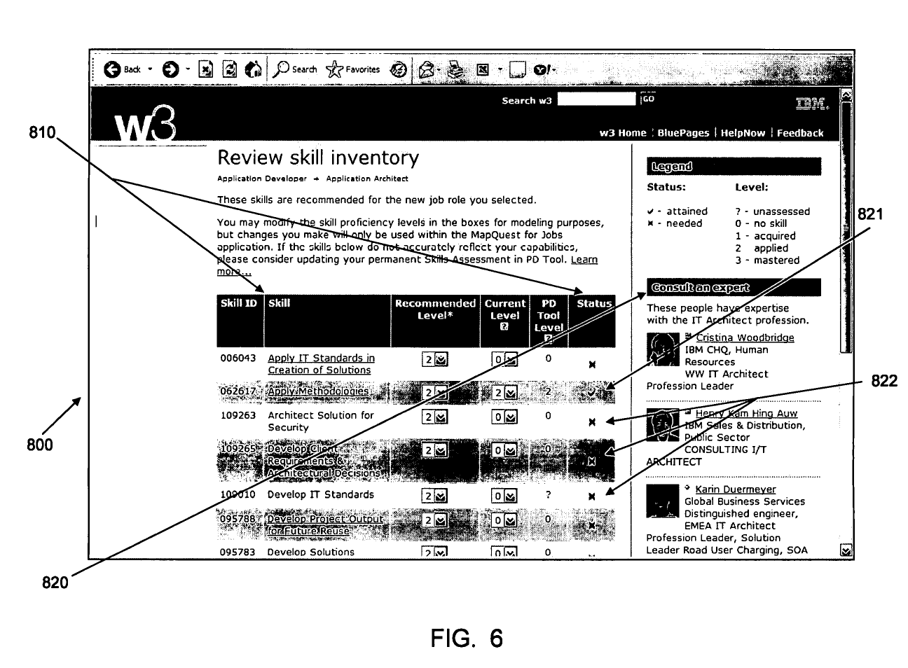

The system displays each difference between the user's documented qualifications and the retrieved qualifications 110 associated with and necessary for the at least one job role. FIG. 6 illustrates a screenshot 800 of an exemplarily embodiment of the career guidance, planning and strategic workforce management tool with a graphical display showing a review of the user's skill set inventory in view of the required skill set inventory for the retrieved target job role. This personalized assessment shows the target job roles skill overlap within the user's current skills and any deficiencies in the user's current skill set 810.

The system retrieves data relating to the training necessary to address the skills gap between the user's documented qualifications (skill set) and the qualifications (skill set) necessary for the at least one job role and provides user specific strategy and recommendations 112 on how to transition from the user's current job into the selected job description or target job role. The strategy and recommendations comprise strategic planning, educational and development recommendations known as a “skill development roadmap.” This “skill development roadmap” 576 includes recommended skill set acquisition and training 578 for each of the selected jobs or job categories. The “skill development road map” preferably identifies formal training available 584 to an employee and provides a timeline 582 projecting the time investment necessary for the employee to develop each of the missing or deficient skills to the level required by the selected job or job category.

Also, the “skill development road map” may identify “milestone jobs roles,” job roles that are a prerequisite or otherwise necessary or advisable for the user to occupy to develop the skill set required for the target job. The skill development may also suggest a strategic order of “milestone job roles” to develop the relevant skill set for the target job as quickly and efficiently as possible, or to afford the organization the maximum value from the employee's current and future skill sets. In addition to the training availability and timeline, the system may also provide the financial resource commitment 580 necessary for the user to develop the required skill set.

The strategy and recommendations may include identifying mentoring resources 574 including managers, human resources representatives, employees who have made a similar transition or people who are currently employed in the specified job description or can otherwise assist the user in implementing the developmental recommendations.

The strategy and recommendations provided may also consider and/or provide information regarding the depth of exposure to specific aspects of a relevant skill, personality factors, past performance, evaluations, non-traditional learning opportunities, or other relevant information as well as recommendations based on the employer's strategic workforce development goals.

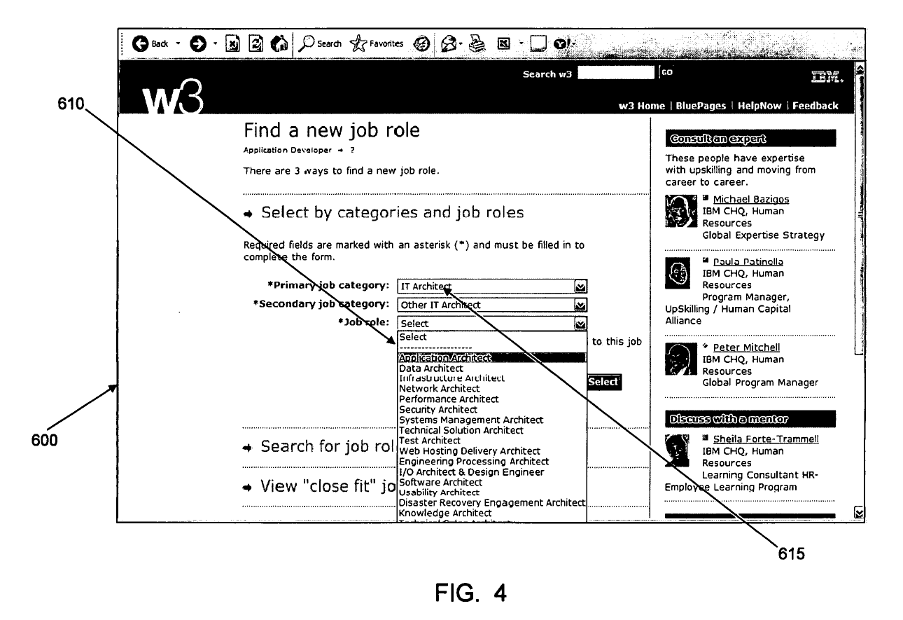

FIG. 4 illustrates a screenshot 600 of an exemplarily embodiment of the career guidance, planning and strategic workforce management tool at the initiation of a job category based search. This screen is presented after the user logs on to the system. From this screen the user selects a target job role for exploration using one of three methods. A user can select a target job based on the primary job category or based on the particular target job role or description. Each search parameter features a pull down screen listing a plurality of job categories 615 or job roles. In FIG. 4, the pull down screen for a job role based search is shown as 610.

When a search is initiated, the standardized skill set for the target job role is retrieved from memory and compared to the skill set contained within the electronic resume. FIG. 6 illustrates a screenshot 800 of an exemplarily embodiment of the career guidance, planning and strategic workforce management tool with a graphical display showing a review of the user's skill set inventory in view of the required skill set inventory for the retrieved target job role. This personalized assessment shows the target job roles skill overlap within the user's current skills and any deficiencies in the user's current skill set 810. The elements of the skill set required for the target job that a user currently possesses are denoted by a checkmark 821 and any skill deficiencies are denoted by an “x” 822 under the skill status line.

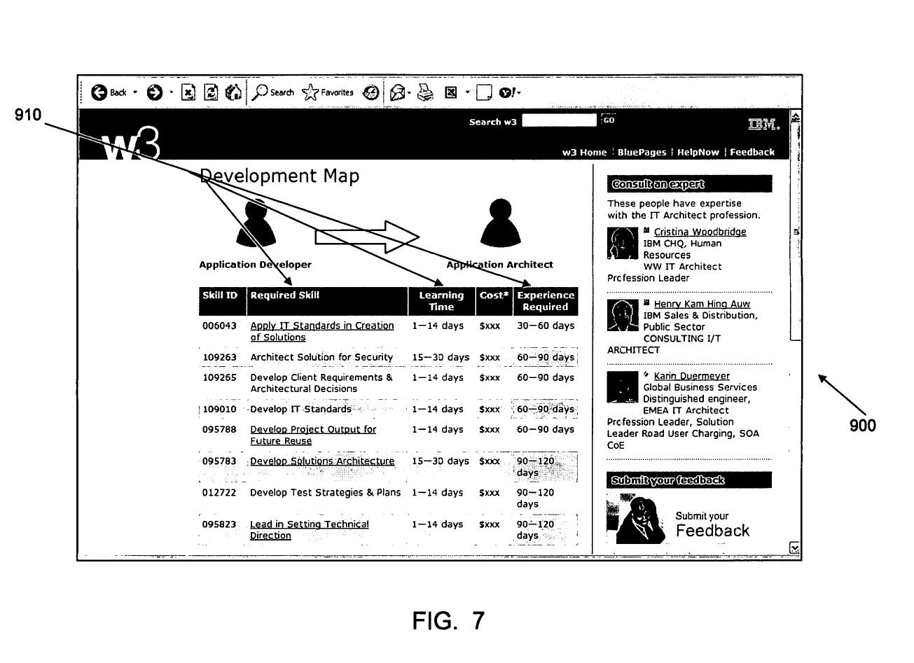

In addition, as shown in the screenshot of FIG. 7, the user may receive contact information for and/or interactive communication with professional resources who have experience, training or other information supporting or assisting the user to reach the target job role 820. Based on the overlap and deficiencies resulting from the skill assessment the user will be provided with individual skill development recommendations.

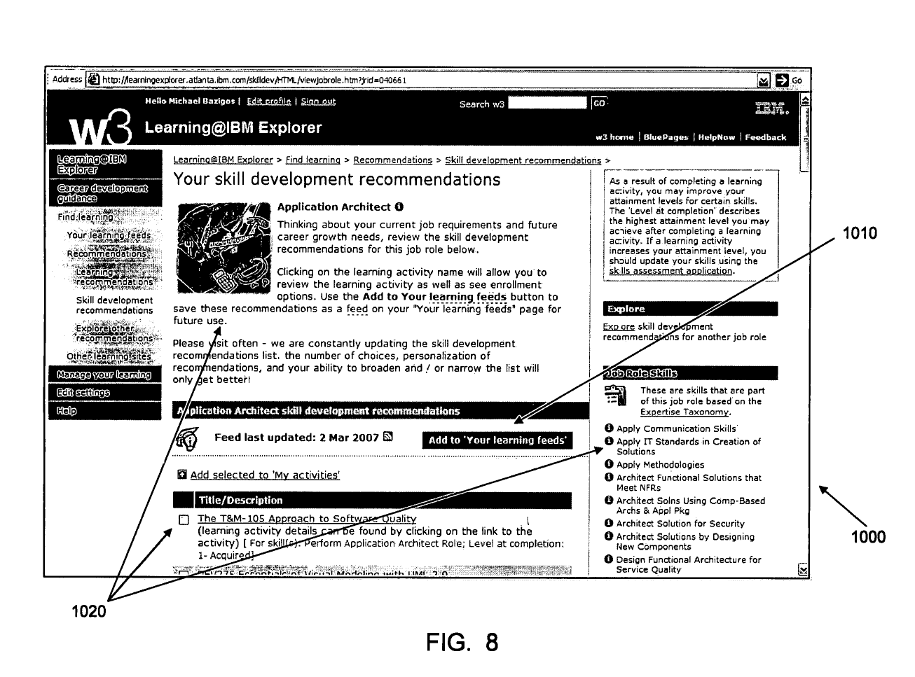

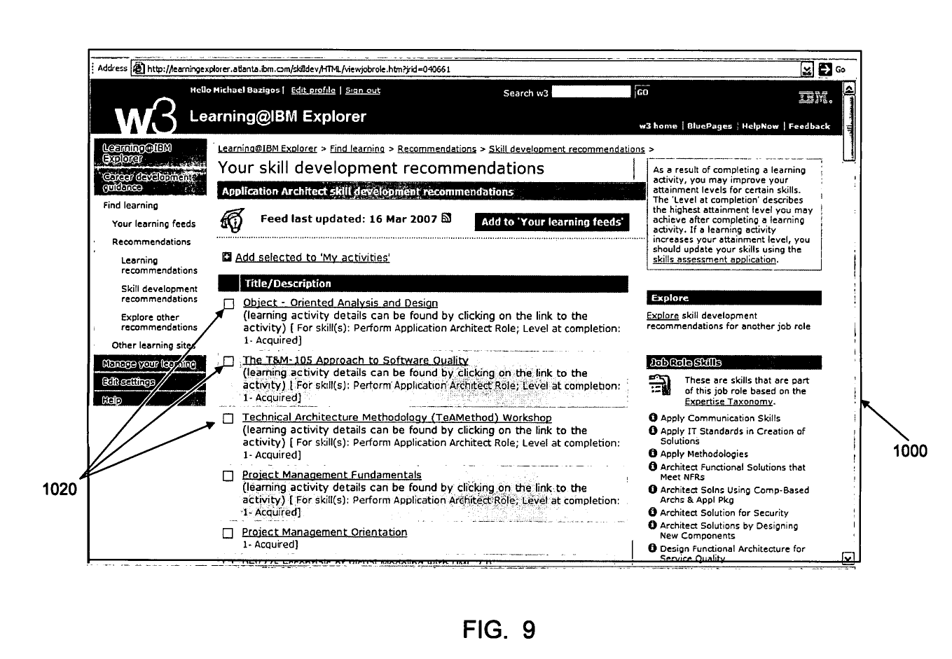

With reference now to FIG. 8 and FIG. 9 which both illustrate screenshots of an example embodiment of the career guidance, planning and strategic workforce management tool showing custom individualized skill development recommendations 1000. The user receives specific role based skill development recommendations 1020. The recommendations also include a list of the skills that are part of the job role and learning recommendations for each needed skill. Also, the user may add the list of recommendation to a personalized account and receive automatic updates (class availability, curriculum changes, changes in schedule, etc.) or track the progress of the development of the employee's skill set 1010.

In yet another embodiment the system performs a “skill set” based job search. In this embodiment the user specifies a search based on his current qualifications as embodied in his electronic resume, looking for job descriptions or job categories that require a skill set that in some way overlaps with his current skill set. The employee may specify a close fit search criteria. The close fit search allows the system to locate a job or job category in which the required skill set for that particular job or category most closely match the employee's current skill set.

Jobs descriptions and categories located through a “close fit” search presumably allow the employee to make a quick and easy transition since the skill set gap is smaller and thus the employee's skill set requires little development.

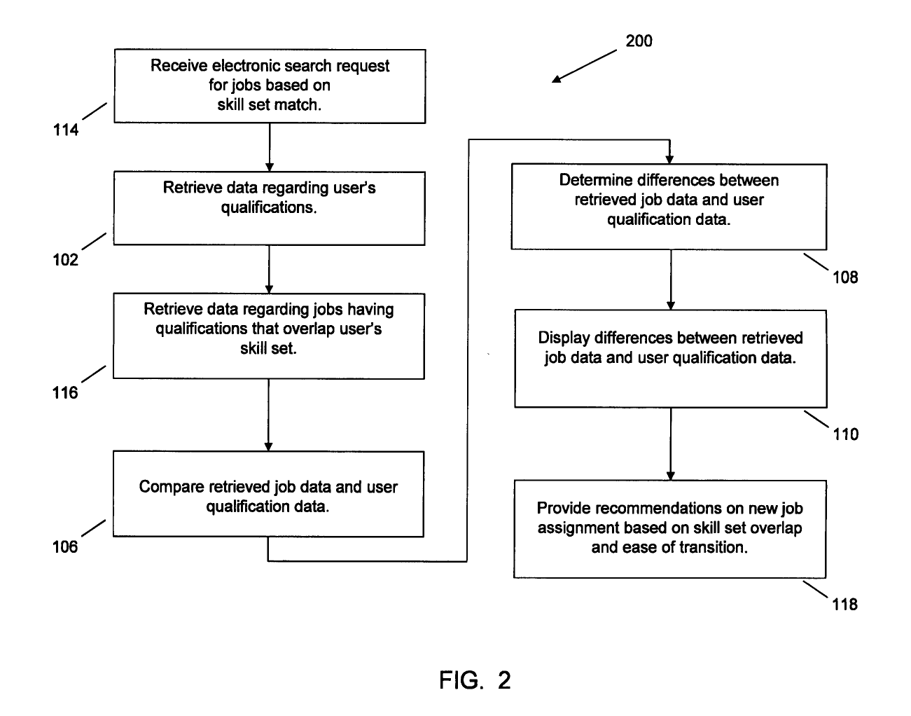

FIG. 2 illustrates an exemplarily flowchart of job search according to the disclosed system and method based on a skill set match search request. Referring now to FIG. 2 with continued reference to FIG. 3, when the system receives an electronic search request for jobs based on a skill set match 114, the system retrieves data regarding the employee's qualifications. This data is the employee's skill set data as embodied in the employee's electronic resume. The system extracts the skill set data from the employee's electronic resume and searches the database, for jobs with a required skill set that overlaps the employee's skill set.

The system retrieves data regarding jobs having qualifications that overlap the employee's skill set 116 and compares the retrieved job data and the user qualification data 106, and determines the differences between the qualification data for the retrieved job and the user's qualification data 108. The differences between the retrieved jobs data and the employee's qualification data are displayed 110 for the employee, and recommendations on a new job roles based on the skill set overlap 118 are provided.

FIG. 6 illustrates a screen shot of an example embodiment of a graphical display of the user's skill set inventory in view of the skill set required for a target job role. The strategy and recommendations comprise strategic planning, educational and development recommendations or a “skill development roadmap.” This “skill development roadmap” 576 includes, recommended skill set acquisition and training 578 for each of the selected jobs or job categories. The “skill development road map” preferably identifies formal training available 584 to an employee and provides a timeline 582, projecting the time investment necessary for the employee to develop each of the missing or deficient skills to the level required by the selected job or job category. Also, the “skill development road map” may identify “milestone jobs roles,” job roles that are a prerequisite or otherwise necessary or advisable for the user to occupy to develop the skill set required for the target job. In addition to the training availability and timeline, the system may also provide the financial resource commitment 580 necessary for the development of the required skill set. In an example embodiment the systems Expertise Taxonomy defines a set of Skills, which are attached to Job Roles and Job Role Skill Sets. However, it may not include a measure of the relative size and complexity of attaining the skill, or measure the value of one skill relative to other skills. Preferably the system maintains extended attributes for each skill which may include a plurality of learning factor extensions and skill value extensions. In the disclosed embodiment the system maintains three learning factor extensions and three skill value extensions.

The three learning factors describe the relative size of the effort to learn a new skill, which indicates the effort to transition from:
The Formal Learning factor f_{FL} to move from skill level 0→1 (Acquired),
The Practical Application factor f_{PA} to move from skill level 1→2 (Applied), and
The Skill Mastery factor f_{SM} to move from skill level 2→3 (Mastered).

These learning effort factors are generally related to estimated transition times in days, weeks, months, or even years according to a predetermined scale. The scale is highly configurable and is preferably set by the management entity. These factors are used to calculate the estimated learning times, estimated learning cost.

In at least one example embodiment the system provides user specific strategy and recommendations on how to transition from the user's current job into the selected job description or target job role. The strategy and recommendations comprise strategic planning, educational and development recommendations known as a “skill development roadmap.” One of the salient features of the “skill development roadmap” is an estimate of the learning time required to develop the set of skills defined in a job role.

The system estimates the learning time required to attain a set of skills defined in a job role (including those in a job category).

This estimated learning time in months, T_{Learn}, may be defined by the following formula:

$${T}_{Learn} = {t}_{FL} {\sum }_{FLgaps} {f}_{FL}^{skill} + {t}_{PA} {\sum }_{PAgaps} {f}_{PA}^{skill}$$

where
The summation FLgaps runs over the set of required skills where the employee does not have at least Acquired skills (Level 1),
The summation over PAgaps runs over the set of required skills where the employee does not have at least Applied skills (Level 2),
f_{FL}^{skill} and f_{PA}^{skill} are the Learning Effort Factors for formal learning (0→1) and practical application (1→2) for those skills where the employees have gaps. These factors vary by skill, and
t_{FL} and t_{PA} are the time constants that convert learning effort factors into times. Each of these terms may vary by business unit.

The T_{Learn} relation may also incorporate the time necessary for the mastery of skills, as shown below.

$${T}_{Learn} = {t}_{FL} {\sum }_{FLgaps} {f}_{FL}^{skill} + {t}_{PA} {\sum }_{PAgaps} {f}_{PA}^{skill} + {t}_{SM} {\sum }_{SMgaps} {f}_{SM}^{skill}$$

where
The summation SMgaps runs over the set of required skills where the employee does not have at least Mastered skills (Level 3),
f_{MS}^{skill} is the Learning Effort Factors for skill mastery (2→3) for those skills where the employees have gaps. This factor varies by skill, and
t_{SM} is the time constant that converts learning effort factors into times. Again, each of these terms may vary by business unit.

Yet another salient, feature of the “skill development roadmap” in the example embodiment is an estimate of the cost of attaining new skills necessary to complete a skill set. In this example embodiment of the system the calculation to estimate the cost of attaining a new set of skills is very similar to one to estimate the time. The only difference is that the different constants are used to convert the learning effort factors.

The application will estimate the cost to attain a set of skills defined in a job role (including those in the primary or secondary job category) and one or more job role skill sets. The estimated learning cost, C_{Learn}, will be defined by the following formula:

$${C}_{Learn} = {c}_{FL} {\sum }_{FLgaps} {f}_{FL}^{skill} + {c}_{PA} {\sum }_{PAgaps} {f}_{PA}^{skill} + {c}_{SM} {\sum }_{SMgaps} {f}_{SM}^{skill}$$

where
The summation FLgaps runs over the set of required skills where the employee does not have at least Acquired skills (Level 1),
The summation over PAgaps runs over the set of required skills where the employee does not have at least Applied skills (Level 2),
The summation SMgaps runs over the set of required skills where the employee does not have at least Mastered skills (Level 3),
f_{FL}^{skill} and f_{PA}^{skill} are the Learning Effort Factors for formal learning (0→1) and practical application (1→2) for those skills where the employees have gaps. f_{MS}^{skill} is the Learning Effort Factors for skill mastery (2→3) for those skills where the employees have gaps. This factor varies by skill, and
C_{FL} and C_{PA} and C_{SM} are the time constants that convert learning effort factors into costs. These terms may vary by business unit.

For each set of the skills associated with a job role (including those associated with its job category) or job role skill set, three Value Skill indicators may be defined. These indicators are salient to the example embodiment's “skill development roadmap” by measuring the progress towards attaining skills for the role combined with a focus on its market, business or professional value. The Progression Realization, is the sum of the first three.

The Market, Business and Professional Value Skill indicators may be defined as follows:

$${I}_{MVS} = \frac{1}{N} {\sum }_{i = 1}^{N} [ {V}_{MVS}^{i} + F ( {L}_{Att}^{i} , {L}_{Req}^{i} ) ]$$

$${I}_{BVS} = \frac{1}{N} {\sum }_{i = 1}^{N} [ {V}_{BVS}^{i} + F ( {L}_{Att}^{i} , {L}_{Req}^{i} ) ]$$

$${I}_{PVS} = \frac{1}{N} {\sum }_{i = 1}^{N} [ {V}_{PVS}^{i} + F ( {L}_{Att}^{i} , {L}_{Req}^{i} ) ]$$

where
N is the number of skills in the set,
The summation runs over all skills in the set,
V_{MVS}ⁱ, V_{BVS}ⁱ and V_{PVS}ⁱ are the coefficients rating the Market, Business and Professional value of skill i, and
F(L_{Att}ⁱ, L_{Req}ⁱ) is the fractional attainment of skill i by the user. Preferably, this would either be 0 or 1 depending on whether or not the user had the skill.

With the default setting where exactly one of V_{MVS}ⁱ, V_{BVS}ⁱ and V_{PVS}ⁱ are equal to 1.0 and the others are equal to 0.0, the value skill indicators will always be on the range from 0.0 to 2.0. An indicator preferably will have a value of 0 when none of the skills in group is of the given type (Market, Business or Professional) and the user does not have any of the skills in the group. An indicator will have its maximum value of 2 when all skills in the group are of the given type and the user has the required capabilities in all of them, however, these variables may be weighted and set in accordance with the business valuation of these factors.

The Progression Realization is the sum of the three indicators defined above. With the simplified initial settings on the value skill coefficients, it may be expressed as follows:

$${I}_{PR} = 1.0 + \frac{3}{N} {\sum }_{i = 1}^{N} F ( {L}_{Att}^{i} , {L}_{Req}^{i} )$$

This indicator ranges in value from 1.0 to 4.0. The minimum value occurs when the user has no skills in the group, and the maximum occurs when the user has the required skill levels in all of them.

The strategy and recommendations may include identifying mentoring resources 574 including managers, human resources representatives, employees who have made similar transition or people who are currently employed in the specified job description or can otherwise assist the employee in implementing the recommendations.

The strategy and recommendations provided may also consider and/or provide information regarding the depth of exposure to relevant skill set, personality factors, past performance, evaluations, non-traditional learning opportunities, or other relevant information as well as recommendations based on the employer's strategic workforce development goals.

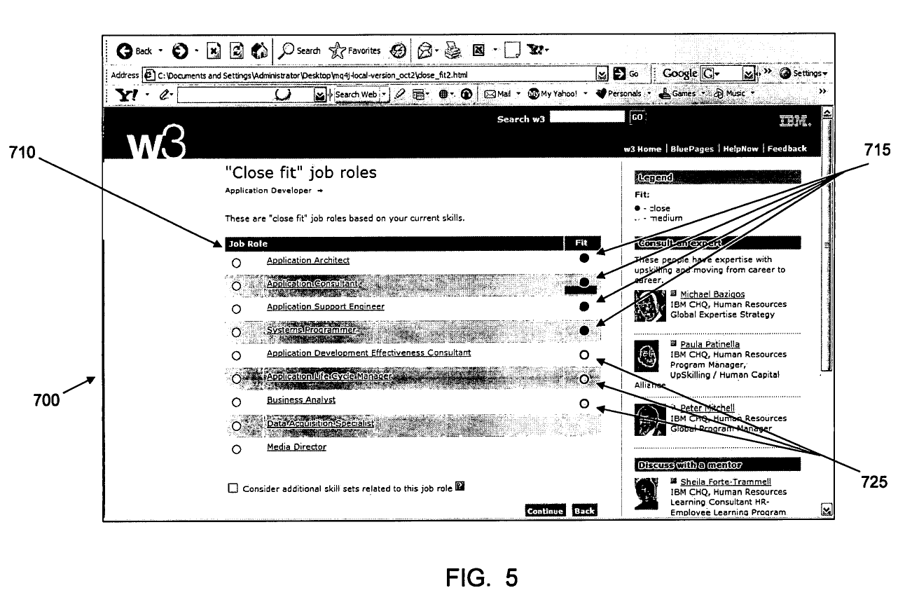

FIG. 5 illustrates a screen shot of an example embodiment of the career guidance, planning and strategic workforce management tool showing results from a skill set based search 700.

As shown in FIG. 5, the exemplarily system has returned results divided into “close fit” and “near fit” job roles 710. The threshold between “close fit” and “near fit” is based on the degree of skill set overlap and may be automatically or manually specified. The calculation of close fit by percentage of skills already attained is defined as follows:

$${F}_{\%} = \frac{100}{N} {\sum }_{i = 1}^{N} F ( {L}_{Att}^{i} , {L}_{Req}^{i} )$$

Jobs returned featuring skill sets that represent a close fit are graphically displayed and denoted by a filled circle 715. Jobs returned featuring skill sets that represent a “near fit” are graphically displayed and denoted by an open circle 725.

In yet another embodiment rather than looking for jobs roles where an employee has a high percentage of the skills required already, they might instead look for jobs where they have the fewest number of new skills to attain. Also, jobs located via a “close fit” skill set based searched presumably require a reduced financial commitment in terms of training. This might lead the employee to lower skilled jobs outside their area, but where they would be able to move to the job role very quickly.

$${F}_{A bs} = {\sum }_{i = 1}^{N} F ( {L}_{Att}^{i} , {L}_{req}^{i} )$$

The sum is over all skills required in the job role.

In yet another example embodiment the system allows a user the ability to override the user's qualification or assessed skill proficiency values and target skill proficiency values allowing “what if” scenario modeling. This feature allows an employee to select any job role, and receive a detailed set of recommendations and a strategic plan that may be implemented over the span of several years. This allows for true strategic career planning and management that may encompass an employee's complete tenure with the organization, allowing a new employee to develop a focused plan and strategy from the onset of employment.

In yet another example embodiment the system offers an employer a workforce and capacity planning feature. This feature allows an employer to select a group of employee accounts or electronic resumes contained in the system and tailor the search results or strategic recommendations provided to those employee's to direct them to, recommend or otherwise emphasize an in-demand job role. The group of employees can be selected based upon skill set, job category, job role, location or other relevant criteria. Also the system can perform a skill set, job category, or job role based search of the employee's accounts and create a list of names for an in-demand job role re-ordered by time-to-competence, or training resource commitment.

When the user selects one of the close fit jobs from this screen, a skill inventory review 800, development map 900 and skill development recommendation 1000 screens as discussed in detail in context of the target job type search follow.

The disclosed invention can take the form of an entirely hardware embodiment, an entirely software embodiment or an embodiment containing both hardware and software elements. In at least one embodiment, the invention is implemented in software, which includes but is not limited to firmware, resident software, microcode, etc.

Referring again to FIG. 10, the invention can take the form of a computer program product 200 accessible from a computer-usable or computer-readable medium providing program code for use by or in connection with a computer or any instruction execution system. For the purposes of this description, a computer-usable or computer readable medium 200 can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory, (CD-ROM), compact disk-read/write (CD-R/W) and DVD.

A data processing system 200 suitable for storing and/or executing program code will include at least one processor 550 coupled directly or indirectly to memory elements 230 through a system bus. The memory elements 230 can include a local memory employed during actual execution of the program code, bulk storage, and cache memories which provide temporary storage of at least some program code in order to reduce the number of times code must be retrieved from bulk storage during execution.

Input/output or I/O devices 210 (including but not limited to keyboards, displays, pointing devices, etc.) can be coupled to the system either directly or through intervening I/O controllers. Network adapters may also be coupled to the system to enable the data processing system to become coupled to other data processing systems 240 or remote printers or storage devices through intervening private or public networks. Modems, cable modem and Ethernet cards are just a few of the currently available types of network adapters.

In yet another example or exemplary embodiment the disclosed invention may be contained within a computer program product 200 featuring computer-usable program code 550 for receiving an electronic request for guidance relating to procuring a job in a particular job category and computer-usable program code 550 for retrieving data relating to the requestor's documented qualifications, as well as computer-usable program code 550 for retrieving data relating to the qualifications necessary for at least one job role in the particular job category. The computer program product also features computer-usable program code 550 for comparing the requestor's current qualifications with the qualifications necessary for the at least one target job role in the particular job category and computer-usable program code 550 for determining the differences between the requestor's current qualifications and the qualifications necessary for the at least one job role.

The computer program product also features computer-usable program 550 code for displaying each difference between the requestor's documented qualifications and the qualifications necessary for the at least one job role and computer-usable program code for retrieving data relating to the training necessary to address the skill gap between the requestor's documented qualifications and the qualifications necessary for the at least one job role. The computer 200 also features computer-usable program code 550 for providing strategy and recommendations on how to transition from the requestor's current job into the at least one target job role.

It will be understood that each block of the flowchart illustrations and block diagrams and combinations of those blocks can be implemented by computer program instructions and/or means.

Although specific example embodiments have been illustrated and described herein, those of ordinary skill in the art appreciate that other variations, aspects, or embodiments may be contemplated, and/or practiced without departing from the scope or the spirit of the appended claims.

1. A method for career guidance and planning comprising the steps of:
receiving an electronic request for guidance relating to procuring a job role in a particular job category;
retrieving data relating to the said electronic request in the form of documented qualifications,
retrieving data relating to required qualifications necessary for at least one job role in said particular job category;
comparing said documented qualifications with said required qualifications necessary for the at least one target job role in said particular job category;
determining the differences between said documented qualifications and said required qualifications necessary for the at least one job role;
displaying at least one difference between said documented qualifications and said required qualifications necessary for the at least one job role;
retrieving data relating to any training necessary to address any skill gap between said documented qualifications and said required qualifications necessary for the at least one job role; and
providing at least one strategy and recommendation response to said electronic request addressing any skill gap between said documented qualifications and the at least one target job role.

2. The method of claim 1 wherein said at least one strategy and recommendation response further comprise at least one recommendation on how to efficiently transition from the current job into the at least one target job role.

3. The method of claim 1 wherein said data relating to said documented qualifications comprise data regarding current and past jobs.

4. The method of claim 1 wherein said data relating to said documented qualifications comprise data regarding education and training.

5. The method of claim 1 wherein said data relating to said documented qualifications comprise data regarding the proficiency relating to at least one skill defined by said skill set.

6. The method of claim 5 wherein said data relating to said documented qualifications comprise skill set data weighted according to the level of proficiency.

7. The method of claim 2 wherein said at least one strategy and recommendation response comprise at least strategic planning, educational and development recommendations based on at least one skill set developed through occupying at least one milestone job.

8. The method of claim 3 wherein said data relating to said required qualifications necessary for at least one job role in said particular job category comprise data regarding the required education and training for said job role.

9. The method of claim 3 wherein said data relating to the required qualifications necessary for at least one job role in said particular job category comprise data regarding the levels of experience and proficiency relating to the skills defined by said skill set.

10. The method of claim 4 wherein said data relating to the qualifications necessary for at least one job role in said particular job category comprise data regarding the required education and training for said job role.

11. The method of claim 4 wherein said data relating to the qualifications necessary for at least one job role in said particular job category comprise data regarding the levels of experience and proficiency relating to the skills defined by said skill set.

12. The method of claim 2 wherein said at least one strategy and recommendation in response to said electronic request considers at least the depth of exposure and proficiency in at least one of the relevant skills in the skill set contained in said documented qualifications.

13. The method of claim 1 wherein said at least one strategy and recommendation in response to said electronic request include, skill set acquisition and training.

14. The method of claim 13 wherein said at least one strategy and recommendation in response to said electronic request include training availability, training costs, and skill development timelines.

15. The method of claim 9 wherein said documented skill set data comprise current and past jobs, education and training, defined skills for each current and past jobs, levels of experience and proficiency for each defined skill.

16. The method of claim 1 wherein said at least one strategy and recommendation response further comprise a skill development roadmap.

17. The method of claim 1 wherein said at least one strategy and recommendation response further comprise at least one imbedded recommendation based on workforce development interests.

18. A method for workforce management and planning comprising:
receiving an electronic request for guidance relating to procuring a job role in a particular job category;
retrieving data relating to said request in the form of documented qualifications,
retrieving data relating to said required qualifications necessary for at least one job role in said particular job category;
comparing said documented qualifications with the required qualifications necessary for the at least one target job role in said particular job category;
determining the differences between said documented qualifications and said required qualifications necessary for the at least one job role;
determining the difference between the documented qualifications and the projected skill set requirements for a job category in a future workforce;
displaying each difference between the documented qualifications and the projected skill set requirements for a job category said future workforce;
retrieving data regarding any training necessary to address the skill gap between said documented qualifications and the required qualifications necessary for the at least one category in said future workforce;
providing at least one strategy and recommendation response to said electronic request addressing any skill gap between the documented qualifications and the at least one target job category in said future workforce.

19. The method of claim 18 further comprising searching a plurality of accounts and developing a list of candidates for a particular job role based on the documented skill set.

20. The method of claim 18 further comprising searching a plurality of accounts and developing a list of candidates for a particular job category based on the resource commitment necessary to address the skill gap between the documented skill set and the skill set required for said particular job category.

21. The method of claim 18 further comprising searching a plurality of accounts and developing a list of candidates for a particular job role based on the resource commitment necessary to address the skill gap between the documented skill set and the skill set required for the particular job role.

22. A method for workforce management and planning comprising:
receiving an electronic request for strategic guidance relating to procuring a job role in a particular job category;
retrieving data relating to documented qualifications,
retrieving data relating to the qualifications necessary for at least one projected job role in said particular job category;
comparing the documented qualifications with the projected qualifications necessary for the at least one future job role in said particular job category;
determining the differences between said documented qualifications and said qualifications necessary for the at least one future job role;
determining the difference between said documented qualifications and the projected skill set requirements for said future job role;
displaying each difference between the documented qualifications and said projected skill set requirements for a job role in the future workforce;
retrieving data regarding the training necessary to address the projected skill gap between the documented qualifications and the qualifications necessary for the at least one job role in said future workforce;
providing at least one strategy and recommendation in response to said electronic request on how to develop the skills necessary to address the skill gap between said documented qualifications and the at least one job category in the employer's future workforce.

23. A system for human resource management and career development comprising:
a computer network having a server coupled to at least one database, said database comprising a plurality of electronic resumes, each said electronic resume of the plurality defining an individual's documented qualifications through at least standardized skill set data associated with an individual's employment history;
a database comprising a plurality of job roles each said job role being defined at least by a set of standardized skills required by said job role, said database being searchable at least by said job role; job category; and at least one skill of a standardized skill set;
said server being coupled to a network having training information contained therein;
wherein in response to an electronic search request based on at least one of said searchable fields, said system retrieves at least one electronic resume of the plurality, and retrieves data relating to the required skill set necessary for at least one target job role;
compares the documented skill set with the required skill set necessary for said at least one identified job role;
determines the differences between the documented skill set and the required skill set necessary for the at least one identified job role;
displays at least one difference between said documented skill set and the required skill set necessary for the at least one identified job role through a user interface;
retrieves data relating to the training necessary to address the skill gap between the documented skill set and the required skill set necessary for the at least one job role, and;
provides at least one strategy and recommendation in response to said electronic request addressing any skill gap between the documented skill set and the skill set required for the at least one identified job role.

24. The system of claim 23 wherein each said electronic resume comprises data relating to a documented skill set, at least one skill comprising said skill set being weighted based on a quantified level of proficiency relating to said skill.

25. The system of claim 23 wherein said data relating to said required qualifications necessary for at least one job role in said particular job category comprise proficiency data.

26. The system of claim 23 wherein said at least one strategy and recommendation provided in response to said electronic request comprise the availability of training to address the identified skill gap.

27. The system of claim 23 wherein said at least one strategy and recommendation provided in response to said electronic request comprise skill set development recommendations with a projected skill set development timeline.

28. The system of claim 23 wherein said at least one strategy and recommendation provided in response to said electronic request comprise skill set development recommendations that feature milestone jobs.

29. The system of claim 23 wherein said at least one strategy and recommendation provided in response to said electronic request comprise at least one imbedded recommendation based on a strategic workforce development plan.

30. The system of claim 29 wherein said at least one strategy and recommendation provided in response to said electronic request is tailored to direct a group of individuals to a predetermined job role based on the skill set data.

31. A computer program product comprising computer usable medium having a computer-usable program code for career guidance and planning said computer program product comprising:
computer-usable program code for receiving an electronic request for guidance relating to procuring a job role in a particular job category;
computer-usable program code for retrieving data relating to the said electronic request in the form of documented qualifications,
computer-usable program code for retrieving data relating to required qualifications necessary for at least one job role in said particular job category;
computer-usable program code for comparing said documented qualifications with said required qualifications necessary for the at least one target job role in said particular job category;
computer-usable program code for determining the differences between said documented qualifications and said required qualifications necessary for the at least one job role;
computer-usable program code for displaying at least one difference between said documented qualifications and said required qualifications necessary for the at least one job role;
computer-usable program code for retrieving data relating to any training necessary to address any skill gap between said documented qualifications and said required qualifications necessary for the at least one job role; and
computer-usable program code for providing at least one strategy and recommendation response to said electronic request addressing any skill gap between said documented qualifications and the at least one target job role.

32. The computer program product of claim 31 wherein said strategy and recommendations include, skill set acquisition and training.
